(19) United States
(12) Patent Application Publication
(10) Pub. No.: US 2026/0308366 A1
(43) Pub. Date: Oct. 8, 2026

(54) RUBBER COMPOSITION AND TIRE

(71) Applicant: THE YOKOHAMA RUBBER CO., LTD., Kanagawa (JP)

(72) Inventors: Takeaki SAIKI, Kanagawa (JP); Takashi SHIROKAWA, Kanagawa (JP); Takamasa KITAMURA, Kanagawa (JP); Yuichiro KARASAWA, Kanagawa (JP); Keisuke AIMU, Kanagawa (JP); Tomoko KAWASUMI, Kanagawa (JP); Kaori OSUMI, Kanagawa (JP); Mingyin HSIAO, Kanagawa (JP); Kenta YAMAMOTO, Kanagawa (JP)

(21) Appl. No.: 19/483,510

(22) PCT Filed: Apr. 18, 2024
(86) PCT No.: PCT/JP2024/015399

§ 371 Date: Nov. 11, 2025

(30) Foreign Application Priority Data
May 16, 2023 (JP) 2023-080608
Nov. 16, 2023 (JP) 2023-194959

(51) Int. Cl. C08L 7/00; B60C 1/00; C08K 3/04; C08K 3/06; C08K 3/22; C08K 3/36; C08K 5/09; C08K 5/18; C08K 5/31; C08K 5/548; C08L 9/00; C08L 23/14

(52) U.S. Cl. CPC C08L 7/00; B60C 1/0016; C08K 3/04; C08K 3/36; C08L 9/00; C08L 23/14; B60C 2200/06; C08K 3/06; C08K 2003/2296; C08K 5/09; C08K 5/18; C08K 5/31; C08K 5/548; C08L 2205/035

(57) ABSTRACT

A rubber composition includes, per 100 parts by mass of a rubber component (A) containing 50 parts by mass or more of a diene rubber, a polyolefin (B) in an amount of from 1 to 200 parts by mass, the polyolefin (B) having a melting point of 110° C. or higher and 155° C. or less and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more.

### TECHNICAL FIELD

The present technology relates to a rubber composition and a tire using the rubber composition.

### BACKGROUND ART

A heavy duty tire such as a truck or bus tire may have a temperature of 100° C. or higher depending on a road surface condition, and is required to be improved because breaking properties are likely to deteriorate under such a high temperature.

Meanwhile, demands for improvement in fuel efficiency for vehicles have been increased from the perspective of the global environment, and development of a tire having good rolling resistance has been desired.

As a known technique for providing a tire having good breaking properties and low heat build-up, for example, Japan Patent No. 6350509 B discloses a rubber composition containing a diene rubber, a filler, and an acid-modified polypropylene-based polymer, wherein the acid-modified polypropylene-based polymer has a melting point of from 136 to 155° C., the content of the acid-modified polypropylene-based polymer is from 1 to 30 parts by mass per 100 parts by mass of the diene rubber, the diene rubber contains a natural rubber, a butadiene rubber, and an aromatic vinyl-conjugated diene copolymer rubber, and the content of the natural rubber is from 15 to 80 mass % with respect to the diene rubber.

Japan Patent No. 3657389 B discloses a rubber composition obtained by blending from 2 to 75 parts by weight of high-density polyethylene (including high-density polyethylene having a crosslinkable portion in an amount of from 35 to 70 wt. %) per 100 parts by weight of a rubber component and kneading the blend at a temperature higher than the melting point of the blended resin.

Japan Unexamined Patent Publication No. 2017-75236 A discloses a rubber composition obtained by blending from 1 to 100 parts by mass of a resin material (B) containing an olefin-based random copolymer (C1) per 100 parts by mass of a diene rubber (A).

However, Japan Patent Nos. 6350509 B and 3657389 B and Japan Unexamined Patent Publication No. 2017-75236 A do not disclose any technical idea for providing a rubber composition for a tire undertread that uses a polyolefin having a specific melting point and a melt mass flow rate in the present technology described below, the rubber composition having excellent strength at break at high temperature and low heat build-up, or having low heat build-up and excellent steering stability.

On the other hand, tires are required to have low rolling resistance because of the reinforcement of international standards under R-117 by the United Nations Economic Commission for Europe (UN/ECE), the reinforcement of greenhouse gas (GHG) regulations by the United States Environmental Protection Agency (EPA), and the like, and thus it is desired to obtain an undertread for heavy duty tires used as tires for trucks and buses having low heat build-up. However, when the undertread has low heat build-up, the hardness and elastic modulus tend to decrease, and there is an issue that securing sufficient steering stability can be difficult.

### SUMMARY

The present technology provides a rubber composition having excellent strength at break at a high temperature and low heat build-up, and a tire using the rubber composition.

The present technology provides a rubber composition for a tire undertread that has low heat build-up and excellent steering stability.

The present technology provides a rubber composition (1) containing, per 100 parts by mass of a rubber component (A) containing 50 parts by mass or more of a diene rubber, a polyolefin (B) in an amount of from 1 to 200 parts by mass, the polyolefin (B) having a melting point of 110° C. or higher and 155° C. or lower and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more.

The present technology provides a rubber composition for a heavy duty tire undertread, the rubber composition containing a rubber component (A2) composed of an isoprene-based rubber and a butadiene rubber, the rubber component having a proportion of the butadiene rubber of 15 parts by mass or less when a total amount of the rubber component (A2) is taken as 100 parts by mass, and per 100 parts by mass of the rubber component; a filler (D) in an amount of 45 parts by mass, the filler (D) composed of carbon black and/or silica having a nitrogen adsorption specific surface area (N₂SA) of from 40 to 130 m²/g; and a high-fluidity random polypropylene (C) in an amount of from 0.1 to 20 parts by mass, the high-fluidity random polypropylene (C) having a melting point of 110° C. or higher and 155° C. or lower and a melt mass flow rate (MFR), measured at a temperature of 230° C. under a load of 2.16 kg, of more than 6 g/10 min.

The rubber composition (1) of the present technology is obtained by blending from 1 to 200 parts by mass of the polyolefin (B) per 100 parts by mass of the rubber component (A). Thus, a rubber composition having excellent strength at break at a high temperature and low heat build-up and a tire using the rubber composition can be obtained.

Since the polyolefin (B) used in the present technology has high fluidity, wettability with the rubber component (A) and entanglement between molecules are promoted, and the polyolefin (B) is well dispersed in the rubber component (A) that is a matrix. In addition, because the melting point of the polyolefin (B) is set to 110° C. or higher and 155° C. or lower, a decrease in strength at break can be suppressed even when the tire has a high temperature when running, and the polyolefin (B) can be melted and dispersed at an economical kneading temperature of rubber. In addition, because the melt mass flow rate (MFR) measured under the conditions of a temperature of 230° C. or 190° C. is set in a specific range, the wettability and entanglement of molecules are promoted, and the polyolefin (B) is suppressed from becoming a foreign substance, and an effect of improving breaking properties and reducing heat generation is exhibited. The polyolefin (B) also exhibits an effect of improving the abrasion resistance of the rubber composition.

According to the rubber composition (2) for a heavy duty tire undertread of the present technology, a rubber composition for a tire undertread that has low heat build-up and excellent steering stability can be provided. The high-fluidity random polypropylene (C) used in the rubber composition (2) for a heavy duty tire undertread of the present technology has high fluidity and low crystallinity. Thus, wettability with the rubber component (A) and entanglement of molecules are promoted, and the high-fluidity random polypropylene (C) is well dispersed in the rubber component (A2) that is a matrix. In addition, because the melt mass flow rate (MFR) measured under the condition of a temperature of 230° C. is set in a specific range in the high-fluidity random polypropylene (C), the wettability and entanglement of molecules are promoted, the high-fluidity random polypropylene (C) is suppressed from becoming a foreign matter, has excellent heat build-up (low heat build-up), and excellent steering stability with increased hardness.

### DETAILED DESCRIPTION

Hereinafter, the present technology will be described in more detail. First, the rubber composition (1) will be described.

### Rubber Component (A)

The rubber component to be used in the rubber composition (1) of the present technology contains a diene rubber in an amount of 50 parts by mass or more when the entire rubber composition is regarded as 100 parts by mass. The diene rubber is not particularly limited. Examples thereof include natural rubber (NR), synthetic isoprene rubber (IR), butadiene rubber (BR), styrene-butadiene copolymer rubber (SBR), and acrylonitrile-butadiene copolymer rubber (NBR). Among these, from the viewpoint of improving the effect of the present technology, a combination system of NR and/or IR and BR is preferable. The molecular weight and the microstructure of the rubber component are not limited. The rubber component may be terminal-modified with an amine, amide, silyl, alkoxysilyl, carboxyl, or hydroxyl group or may be epoxidized.

In a preferred embodiment of the present technology, the rubber component (A) is preferably composed of a diene rubber.

### Polyolefin (B)

The polyolefin (B) used in the rubber composition (1) of the present technology is a high-fluidity polyolefin having a melting point of 110° C. or higher and 155° C. or lower, having a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more.

From the viewpoint of improving the effect of the present technology, the melting point of the polyolefin (B) is preferably 130° C. or higher and 150° C. or lower.

From the viewpoint of improving the effect of the present technology, the melt mass flow rate (MFR) of the polyolefin (B) measured at a temperature of 230° C. under a load of 2.16 kg is more than 6 g/10 min, preferably 8 g/10 min or more. The upper limit value of the MFR is, for example, preferably 5000 g/10 min or less, more preferably 1000 g/10 min or less, still more preferably 500 g/10 min or less, more preferably less than 100 g/10 min.

From the viewpoint of improving the effect of the present technology, the melt mass flow rate (MFR) of the polyolefin (B) measured at a temperature of 190° C. under a load of 2.16 kg is preferably 10 g/10 min or more, more preferably 20 g/10 min or more. The upper limit value of the MFR is, for example, preferably 5000 g/10 min or less, more preferably 1000 g/10 min or less, particularly preferably 500 g/10 min or less.

In the description of the present specification, the melting point is measured at a rate of temperature increase of 10° C./min through a differential scanning calorimetry (DSC) in accordance with ASTM D 3418. The melt mass flow rate (MFR) is measured at a temperature of 190° C. or 230° C. under a load of 2.16 kg as described above in accordance with “Plastics-Determination of the melt mass flow rate (MFR) of thermoplastics” stipulated in JIS (Japanese Industrial Standard) K 7210:1999. In the measurement conditions of the MFR, the temperature of 230° C. is employed for random polypropylene, and the temperature of 190° C. is employed for other polyolefins.

Examples of the polyolefin (B) include polyethylene such as high-density polyethylene (HDPE), low-density polyethylene (LDPE), linear low-density polyethylene (LLDPE), and ultra-low-density polyethylene (ULDPE); random polypropylene such as a propylene-ethylene random copolymer, a propylene-1-butene random copolymer, and a propylene-ethylene-1-butene random copolymer; ethylene-α-olefin copolymers such as an ethylene-propylene copolymer (EPR), an ethylene-butene copolymer (EBR), an ethylene-pentene copolymer, an ethylene-hexene copolymer, and an ethylene-octene copolymer; ethylene-(meth)acrylic acid ester copolymers, ethylene-vinyl acetate copolymers (EVA), propylene-ethylene block copolymers, and propylene-butene block copolymers. Among these, from the viewpoint of improving the effect of the present technology, at least one selected from the group consisting of a propylene-ethylene random copolymer, a propylene-1-butene random copolymer, a propylene-ethylene-1-butene random copolymer, LDPE, LLDPE, and HDPE is preferable. An ethylene-(meth)acrylic acid ester copolymer and an ethylene-vinyl acetate copolymer (EVA) preferably include an amount of a contained polar monomer of from 1 to 60 mass %. As the polyolefin (B) used in the present technology, any comonomers other than those described above can be employed as long as the conditions of the melting point and MFR of the present technology can be satisfied.

From the viewpoint of improving the effect of the present technology, the polyolefin (B) used in the rubber composition (1) of the present technology is also preferably a high-fluidity polyolefin having a hydrolytically condensable silyl group (hereinafter, may be referred to as silyl group-containing polyolefin) or an acid-modified high-fluidity polyolefin.

The silyl group-containing polyolefin or the acid-modified high-fluidity polyolefin is obtained, for example, by grafting a hydrolytically condensable silane compound or an unsaturated carboxylic acid (or a derivative thereof) onto a polyolefin that is a base resin.

Specifically, the polyolefin and a free-radical generator are allowed to coexist and heated to decompose the free-radical generator. A reaction step can be employed in which the generated free radicals extract hydrogen from the polyolefin to generate polymer radicals, and a hydrolytically condensable silane compound or an unsaturated carboxylic acid (or a derivative thereof) is added to the polymer radicals.

Examples of the hydrolytically condensable silane compound that can be used include vinylsilane compounds such as vinyltrimethoxysilane, vinyltriethoxysilane, and vinyltris(β-methoxyethoxy)silane; aminosilane compounds such as γ-aminopropyltrimethoxysilane, γ-aminopropyltriethoxysilane, N-β-(aminoethyl)-γ-aminopropyltrimethoxysilane, β-(aminoethyl)-γ-aminopropylmethyldimethoxysilane, and N-phenyl-γ-aminopropyltrimethoxysilane; epoxysilane compounds such as β-(3,4-epoxycyclohexyl)ethyltrimethoxysilane, γ-glycidoxypropyltrimethoxysilane, and γ-glycidoxypropylmethyldiethoxysilane; acrylic silane compounds such as γ-methacryloxypropyltrimethoxysilane; polysulfide silane compounds such as bis(3-(triethoxysilyl)propyl)disulfide and bis(3-(triethoxysilyl)propyl)tetrasulfide; and mercaptosilane compounds such as 3-mercaptopropyltrimethoxysilane and 3-mercaptopropyltriethoxysilane.

Examples of the unsaturated carboxylic acid include (meth)acrylic acid, maleic acid, fumaric acid, tetrahydrophthalic acid, itaconic acid, citraconic acid, crotonic acid, and isocrotonic acid. Among these, maleic acid is preferable. One or more unsaturated carboxylic acids may be used.

Examples of the derivatives of the unsaturated carboxylic acids include an acid anhydride, an acid halide, an amide, an imide, an ester, and a salt of the unsaturated carboxylic acids. Among these, an acid anhydride of an unsaturated carboxylic acid is preferable, and maleic anhydride is more preferable.

Examples of the free-radical generator that can be used include known organic peroxides and, for example, dicumyl peroxide, benzoyl peroxide, 1,1-bis(t-butylperoxy)-3,3,5-trimethylcyclohexane, t-butyl peroxy isopropyl carbonate, t-butyl peroxybenzoate, 2,5-dimethyl-2,5-bis(benzoylperoxy)hexane, methyl ethyl ketone peroxide, 2,2-bis(t-butylperoxy)butane, and cumene hydroperoxide.

Examples of the conditions of the reaction step described above that subjects the polyolefin that is a base resin to graft copolymerization with the hydrolytically condensable silane compound or an unsaturated carboxylic acid (or a derivative thereof) include conditions of blending from 0.1 to 10 parts by mass of the hydrolytically condensable silane compound per 100 parts by mass of the polyolefin as a base resin and mixing the obtained blend at a temperature equal to or higher than the melting point of the polyolefin. The addition amount of the free-radical generator is, for example, approximately from 0.01 to 0.5 parts by mass per 100 parts by mass of the polyolefin described above. The reaction conditions of the graft copolymerization are known and are, for example, described in Japan Patent No. 5768696 B. During the reaction step described above, a known additive such as an antioxidant can be added to the reaction system. In the case of obtaining an acid-modified high-fluidity polyolefin, the same known reaction conditions as described above can be employed.

From the viewpoint of improving the effect of the present technology, the density of the polyolefin (B) is, for example, preferably 0.860 g/cm³ or more and 1.000 g/cm³ or less, more preferably 0.880 g/cm³ or more and 0.980 g/cm³ or less, particularly preferably 0.890 g/cm³ or more and 0.970 g/cm³ or less.

The density in the present technology can be measured by the method described in JIS K7112. When the polyolefin (B) is a silyl group-containing polyolefin, the density of the polyolefin (B) refers to the density of an unmodified polyolefin as a base resin before having a hydrolytically condensable silyl group.

The morphology and/or dispersion state of the polyolefin (B) in the rubber composition (1) may be in any form.

### Carbon Black

The rubber composition (1) of the present technology may contain carbon black. The carbon black used in the present technology preferably has a nitrogen adsorption specific surface area (N₂SA) of from 20 to 300 m²/g, more preferably from 40 to 150 m²/g from the viewpoint of improving the effect of the present technology.

The nitrogen adsorption specific surface area (N₂SA) is a value determined in accordance with JIS K 6217-2.

### Silica

The rubber composition (1) of the present technology may contain silica. The silica used in the present technology preferably has a nitrogen adsorption specific surface area N₂SA of from 20 to 300 m²/g, more preferably from 80 to 250 m²/g, from the viewpoint of improving the effect of the present technology.

### Blending Proportion of Rubber Composition (1)

The rubber composition (1) of the present technology is obtained by blending the polyolefin (B) in an amount of from 1 to 200 parts by mass per 100 parts by mass of the rubber component (A).

When the blending amount of the polyolefin (B) is less than 1 part by mass, the blending amount is too small to exhibit the effect of the present technology. When the blending amount is more than 200 parts by mass, rubber elasticity significantly decreases.

In the rubber composition of the present technology, the blending amount of the polyolefin (B) is preferably from 1 to 150 parts by mass, more preferably from 2 to 100 parts by mass, particularly preferably from 5 to 50 parts by mass per 100 parts by mass of the rubber component.

In the rubber composition (1) of the present technology, the blending amount of carbon black and/or silica is preferably from 20 to 200 parts by mass per 100 parts by mass of the rubber component.

Specifically, in the rubber composition (1) of the present technology, the blending amount of carbon black is preferably from 5 to 200 parts by mass per 100 parts by mass of the rubber component, and the blending amount of silica is preferably from 0 to 195 parts by mass, still more preferably 5 parts by mass or more, particularly preferably from 5 to 100 parts by mass per 100 parts by mass of the rubber component.

When the rubber composition (1) of the present technology is used for a tire tread, the rubber component (A) is preferably composed of isoprene-based rubber and/or butadiene rubber and/or styrene-butadiene rubber, and the proportion of a filler composed of carbon black and/or silica is preferably from 40 to 80 parts by mass per 100 parts by mass of the rubber component (A). When carbon black is used, the nitrogen adsorption specific surface area (N₂SA) thereof is preferably from 90 to 130 m²/g.

When the rubber composition (1) of the present technology is used for a sidewall, the rubber component (A) is preferably composed of isoprene-based rubber and butadiene rubber, and the proportion of the filler composed of carbon black and/or silica is preferably from 30 to 50 parts by mass per 100 parts by mass of the rubber component (A). When carbon black is used, the nitrogen adsorption specific surface area (N₂SA) thereof is preferably from 40 to 90 m²/g.

When the rubber composition (1) of the present technology is used for a rim cushion, the rubber component (A) is preferably composed of isoprene-based rubber and/or butadiene rubber, and the proportion of the filler composed of carbon black and/or silica is preferably from 40 to 80 parts by mass per 100 parts by mass of the rubber component (A). When carbon black is used, the nitrogen adsorption specific surface area (N₂SA) thereof is preferably from 40 to 120 m²/g.

When the rubber composition (1) of the present technology is used for a bead filler, the rubber component (A) is preferably composed of isoprene-based rubber and/or styrene-butadiene rubber, and the proportion of the filler composed of carbon black and/or silica is preferably from 30 to 80 parts by mass per 100 parts by mass of the rubber component (A). When carbon black is used, the nitrogen adsorption specific surface area (N₂SA) thereof is preferably from 40 to 120 m²/g.

### Additional Components

The rubber composition (1) in the present technology can be blended with, in addition to the components described above, various additives commonly blended in rubber compositions, such as vulcanizing or crosslinking agents; vulcanizing or crosslinking accelerators; various fillers, such as clay, talc, calcium carbonate, and aluminum hydroxide; anti-aging agents; plasticizers; resins; curing agents; silane coupling agents; and processing aids. The additives are kneaded by a common method to obtain a composition that can then be used for vulcanization or crosslinking. The blending amount of such an additive may be any standard blending amount in the related art, as long as the present technology is not hindered.

A method for producing the rubber composition (1) according to the present technology includes a blending step of blending a polyolefin (B) in an amount of from 1 to 200 parts by mass per 100 parts by mass of a rubber component (A), and a kneading step of kneading the obtained blend under a condition of a temperature equal to or higher than a melting point of the polyolefin (B). After the kneading step, a vulcanizing step may be performed under a condition of a temperature equal to or higher than the melting point the polyolefin (B). The kneading and the vulcanization can be performed using a known apparatus under known conditions.

The rubber composition (1) of the present technology is preferably used for a tread of a tire, and more preferably used for a tread of a heavy duty tire, a sidewall of a heavy duty tire, a rim cushion of a heavy duty tire, and a bead filler of a heavy duty tire, because the rubber composition (1) has excellent strength at break under high temperature and low heat build-up. The tire of the present technology is preferably a pneumatic tire, and can be inflated with air, an inert gas such as nitrogen, or another gas.

Next, the rubber composition (2) for a heavy duty tire undertread of the present technology will be described.

A rubber composition for a heavy duty tire undertread (2) (hereinafter, may be simply referred to as rubber composition (2)) of the present technology is a rubber component (A2) containing an isoprene-based rubber and a butadiene rubber, the rubber component containing, per 100 parts by mass of the rubber component in which a proportion of the butadiene rubber is 15 parts by mass or less when a total amount of the rubber component (A2) is taken as 100 parts by mass: a filler (D) in an amount of 45 parts by mass, the filler (D) being composed of carbon black and/or silica having a nitrogen adsorption specific surface area (N₂SA) of from 40 to 130 m²/g; and a high-fluidity random polypropylene (C) in an amount of from 0.1 to 20 parts by mass, the high-fluidity random polypropylene (C) having a melting point of 110° C. or higher and 155° C. or lower and a melt mass flow rate (MFR), measured at a temperature of 230° C. under a load of 2.16 kg, of more than 6 g/10 min.

In the rubber composition (2) of the present technology, it is preferable that the rubber component (A2) is composed of an isoprene-based rubber and a butadiene rubber (BR), and the proportion of the butadiene rubber is 15 parts by mass or less when a total amount of the rubber component (A) is taken as 100 parts by mass. Examples of the isoprene-based rubber include natural rubber (NR) and synthetic isoprene rubber (IR). In the rubber component (A2), the proportion of BR is preferably from 5 to 15 parts by mass when the total amount of the rubber component (A2) is taken as 100 parts by mass.

### Filler (D)

The rubber composition (2) of the present technology contains a filler composed of carbon black and/or silica.

The carbon black (D) used in the rubber composition (2) of the present technology preferably has a nitrogen adsorption specific surface area (N₂SA) of from 40 to 130 m²/g, more preferably 40 m²/g or more and less than 100 m²/g from the viewpoint of improving the effect of the present technology.

On the other hand, as the silica, from the viewpoint of improving the effect of the present technology, the nitrogen adsorption specific surface area (N₂SA) is preferably from 80 to 160 m²/g, more preferably from 80 to 100 m²/g.

### High-Fluidity Random Polypropylene (C)

The high-fluidity random polypropylene (C) used in the rubber composition (2) of the present technology has a melting point of 110° C. or higher and 155° C. or lower, and a melt mass flow rate (MFR), measured at a temperature of 230° C. under a load of 2.16 kg, of more than 6 g/10 min.

From the viewpoint of improving the effect of the present technology, the melt mass flow rate (MFR) of the high-fluidity random polypropylene (C) measured at a temperature of 230° C. under a load of 2.16 kg is preferably 8 g/10 min or more, and the upper limit value of the melt mass flow rate (MFR) is preferably less than 12 g/10 min.

From the viewpoint of improving the effect of the present technology, the melting point of the high-fluidity random polypropylene (C) is preferably 130° C. or higher and 160° C. or lower, more preferably 130° C. or higher and 150° C. or lower.

Examples of the type of the high-fluidity random polypropylene (C) used in the rubber composition (2) of the present technology include a propylene-ethylene random copolymer, a propylene-1-butene random copolymer, and a propylene-ethylene-1-butene random copolymer, and these are preferred forms from the viewpoint of the effect of the present technology. As the high-fluidity random polypropylene (C) used in the present technology, any comonomers other than those described above can be employed as long as the conditions of the MFR of the present technology can be satisfied.

The high-fluidity random polypropylene (C) used in the rubber composition (2) of the present technology can have a hydrolytically condensable silyl group in the molecule. Various conditions for introducing a hydrolytically condensable silyl group into the molecule of the high-fluidity random polypropylene (C) are the same as those for the silyl group-containing polyolefin described in the rubber composition (1) of the present technology.

### Blending Proportion of Rubber Composition (2)

The rubber composition (2) of the present technology contains, per 100 parts by mass of the rubber component (A2), a filler (D) in an amount of 45 parts by mass or less composed of carbon black and/or silica having a nitrogen adsorption specific surface area (N₂SA) of from 40 to 130 m²/g and a high-fluidity random polypropylene (C) in an amount of from 0.1 to 20 parts by mass having a melting point of 110° C. or higher and 155° C. or lower and a melt mass flow rate (MFR), measured at a temperature of 230° C. under a load of 2.16 kg, of more than 6 g/10 min.

When the blending amount of the filler (D) exceeds 45 parts by mass, the heat build-up deteriorates.

When the blending amount of the high-fluidity random polypropylene (C) is less than 0.1 parts by mass, the blending amount is too small to exhibit the effect of the present technology, and conversely, when the blending amount exceeds 20 parts by mass, the heat build-up and the steering stability deteriorate.

In the filler (D), the blending amount of carbon black is preferably from 30 to 45 parts by mass, more preferably from 30 to 40 parts by mass, per 100 parts by mass of the rubber component (A2). The blending amount of silica is preferably from 5 to 15 parts by mass, more preferably from 5 to 10 parts by mass, per 100 parts by mass of the rubber component (A2).

In the rubber composition (2) of the present technology, the blending amount of the high-fluidity random polypropylene (C) is preferably from 3 to 8 parts by mass per 100 parts by mass of the rubber component (A2).

### Additional Components

Additional components can be blended in the rubber composition (2) of the present technology in the same manner as described in the rubber composition (1). The method for producing the rubber composition (2) of the present technology is also the same as the method for producing the rubber composition (1).

The rubber composition (2) of the present technology has excellent heat build-up (low heat build-up), and has high hardness to impart excellent steering stability, and thus is preferably used for an undertread of a heavy duty tire. The tire of the present technology is preferably a pneumatic tire, and can be inflated with air, an inert gas such as nitrogen, or another gas.

### EXAMPLES

Hereinafter, the present technology will be described in further detail by way of Examples and Comparative Examples, but the present technology is not limited to these examples.

First, Examples and Comparative Examples of the rubber composition (1) of the present technology will be described.

### Preparation of Various Polyolefins

The following materials were used as random polypropylenes.
Random polypropylene A: NOVATEC PP MG05ES available from Japan Polypropylene Corporation
Random polypropylene B: SunAllomer PM731V available from SunAllomer Ltd.
Random polypropylene C: SunAllomer PM931M available from SunAllomer Ltd.
Random polypropylene D: SunAllomer PM940M available from SunAllomer Ltd.
Random polypropylene E: SunAllomer PMA20V available from SunAllomer Ltd.
Random polypropylene F: Prime Polypro E-333GV available from Prime Polymer Co., Ltd.

The melting points and melt mass flow rates (MFR) of the various random polypropylenes measured at a temperature of 230° C. under a load of 2.16 kg are listed in Table 1 below.

TABLE 1

| | | | | | | For |
|---|---|---|---|---|---|---|
| | | | | | | Compar- |
| | | | | | | ative |
| | For Examples | | | | | Examples |
| Random polypropylene | A | B | C | D | E | F |
| Melting point (° C.) | 148 | 145 | 145 | 135 | 147 | 147 |
| MFR (g/10 min) | 45 | 9.5 | 25 | 30 | 45 | 2.4 |
| temperature 230° C., | | | | | | |
| load 2.16 kg | | | | | | |

The following materials were used as polyolefins other than random polypropylene.
Polyolefin G (HDPE): NOVATEC HD HJ590N available from Japan Polyethylene Corporation
Polyolefin H (HDPE): NOVATEC HD HJ580N available from Japan Polyethylene Corporation
Polyolefin I (HDPE): NOVATEC HD HJ362N available from Japan Polyethylene Corporation
Polyolefin J (LDPE): NOVATEC LD LJ902 available from Japan Polyethylene Corporation

The melting points and melt mass flow rates (MFR) of the various polyolefins measured at a temperature of 190° C. under a load of 2.16 kg are listed in Table 2 below.

TABLE 2

| | | | For Comparative | |
|---|---|---|---|---|
| | For Examples | | Examples | |
| Polyolefin | G | H | I | J |
| Melting point (° C.) | 133 | 134 | 132 | 102 |
| MFR (g/10 min) temperature | 40 | 12 | 5 | 45 |
| 190° C., load 2.16 kg | | | | |

### Standard Example 1, Examples 1 to 6, and Comparative Example 1

### Preparation of Sample

According to the blending proportion (parts by mass) listed in Table 3, the components other than the vulcanization components (vulcanization accelerators and sulfur) were mixed for 5 minutes in a Banbury mixer at 80° C. The temperature reached at that time was 150° C. Then, the vulcanization components were added and mixed by using a roll and thus a rubber composition was obtained. A vulcanized rubber test piece was produced by press-vulcanizing each obtained rubber composition (unvulcanized) at 170° C. for 10 minutes in a mold (15 cm×15 cm×0.2 cm), and the following evaluations were performed.

### Strength at Break and Elongation at Break

For the vulcanized rubber test pieces produced as described above, dumbbell-shaped JIS No. 3 test pieces (thickness: 2 mm) were punched in accordance with JIS K 6251. The strength at break and the elongation at break were measured by performing a test at a pulling speed of 500 mm/min under an atmosphere of 20° C. or 100° C. The obtained results were listed in the columns “Strength at Break” and “Elongation at break” as index values with the value in Standard Example 1 as 100. A larger index value indicates a stronger strength at break and elongation at break and excellent mechanical properties.

### Heat Build-Up: tan δ (60° C.) Index

The loss tangent at a temperature of 60° C., tan δ (60° C.), was measured for each of the vulcanized rubber test pieces produced as described above using a viscoelastic spectrometer (available from Toyo Seiki Seisaku-sho, Ltd.) under the following conditions: 10% initial strain, ±2% amplitude, and 20 Hz frequency, and the heat build-up was evaluated.

The reciprocal of the obtained tan δ (60° C.) was calculated, and the result was listed in the column of “Heat build-up” as an index with the value of Standard Example 1 as 100. The larger these indexes are, the lower heat build-up are, which is preferable.

The results are listed in Table 3.

TABLE 3-1

| | | Standard | Example | Example | Example | Example |
|---|---|---|---|---|---|---|
| | | Example 1 | 1A | 2 | 3 | 4 |
| NR *1 | | 50 | 50 | 50 | 50 | 50 |
| BR *2 | | 50 | 50 | 50 | 50 | 50 |
| Polyolefin | Random | | 10 | | | |
| (B) | polypropylene A | | | | | |
| | Random | | | 10 | | |
| | polypropylene B | | | | | |
| | Random | | | | 10 | |
| | polypropylene C | | | | | |
| | Random | | | | | 10 |
| | polypropylene D | | | | | |
| | Random | | | | | |
| | polypropylene E | | | | | |
| | Random | | | | | |
| | polypropylene F | | | | | |

| | | | | | |
|---|---|---|---|---|---|
| Silica *3 | 30 | 30 | 30 | 30 | 30 |
| Carbon black *4 | 10 | 10 | 10 | 10 | 10 |
| Silane coupling agent *5 | 2 | 2 | 2 | 2 | 2 |
| Zinc oxide *6 | 3 | 3 | 3 | 3 | 3 |
| Stearic acid *7 | 1.5 | 1.5 | 1.5 | 1.5 | 1.5 |
| Anti-aging agent *8 | 2 | 2 | 2 | 2 | 2 |
| Sulfur *9 | 2 | 2 | 2 | 2 | 2 |
| Vulcanization accelerator NS | 1.5 | 1.5 | 1.5 | 1.5 | 1.5 |
| *10 | | | | | |
| Vulcanization accelerator D | 0.5 | 0.5 | 0.5 | 0.5 | 0.5 |
| *11 | | | | | |
| Measurement result | | | | | |
| Strength at break at 20° C. | 100 | 112 | 105 | 111 | 102 |
| Elongation at break at 20° C. | 100 | 111 | 104 | 109 | 103 |
| Strength at break at 100° C. | 100 | 111 | 115 | 120 | 113 |
| Elongation at break at 100° C. | 100 | 118 | 118 | 124 | 121 |
| Heat build-up | 100 | 133 | 115 | 134 | 138 |

TABLE 3-2

| | | Example | Comparative | Example | Example | Example |
|---|---|---|---|---|---|---|
| | | 5 | Example 1 | 6 | 1B | 1C |
| NR *1 | | 50 | 50 | 100 | 50 | 50 |
| BR *2 | | 50 | 50 | | 50 | 50 |
| Polyolefin | Random | | | 10 | 50 | 100 |
| (B) | polypropylene A | | | | | |
| | Random | | | | | |
| | polypropylene B | | | | | |
| | Random | | | | | |
| | polypropylene C | | | | | |
| | Random | | | | | |
| | polypropylene D | | | | | |
| | Random | 10 | | | | |
| | polypropylene E | | | | | |
| | Random | | 10 | | | |
| | polypropylene F | | | | | |

| | | | | | |
|---|---|---|---|---|---|
| Silica *3 | 30 | 30 | 30 | 30 | 30 |
| Carbon black *4 | 10 | 10 | 10 | 10 | 10 |
| Silane coupling agent *5 | 2 | 2 | 2 | 2 | 2 |
| Zinc oxide *6 | 3 | 3 | 3 | 3 | 3 |
| Stearic acid *7 | 1.5 | 1.5 | 1.5 | 1.5 | 1.5 |
| Anti-aging agent *8 | 2 | 2 | 2 | 2 | 2 |
| Sulfur *9 | 2 | 2 | 2 | 2 | 2 |
| Vulcanization accelerator NS | 1.5 | 1.5 | 1.5 | 1.5 | 1.5 |
| *10 | | | | | |
| Vulcanization accelerator D | 0.5 | 0.5 | 0.5 | 0.5 | 0.5 |
| *11 | | | | | |
| Measurement result | | | | | |
| Strength at break at 20° C. | 102 | 104 | 127 | 225 | 242 |
| Elongation at break at 20° C. | 102 | 88 | 111 | 160 | 176 |
| Strength at break at 100° C. | 111 | 100 | 151 | 196 | 201 |
| Elongation at break at 100° C. | 117 | 98 | 144 | 184 | 191 |
| Heat build-up | 140 | 100 | 129 | 171 | 189 |

*1: NR (SIR20)
*2: BR (Nipol BR1220, available from Zeon Corporation; number-average molecular weight = 1.8 × 10⁵)
*3: Silica (ULTRASIL VN3GR available from Evonik Industries AG, nitrogen adsorption specific surface area (N₂SA) = 177 m²/g, CTAB specific surface area = 166 m²/g)
*4: Carbon black (trade name: Show Black N339, available from Cabot Japan K.K., CTAB specific surface area = 90 m²/g)
*5: Silane coupling agent (Si69, available from Evonik Degussa, bis(3-triethoxysilylpropyl)tetrasulfide)
*6: Zinc oxide (Zinc Oxide III, available from Seido Chemical Industry Co., Ltd.)
*7: Stearic acid (Stearic acid YR, available from NOF Corporation)
*8: Anti-aging agent (Santoflex 6PPD, available from Flexsys)
*9: Sulfur (oil-treated sulfur, available from Karuizawa Refinery Ltd.)
*10: Vulcanization accelerator NS (SANCELER NS-G, available from Sanshin Chemical Industry Co., Ltd.)
*11: Vulcanization accelerator D (NOCCELER D, available from Ouchi Shinko Chemical Industrial Co., Ltd.)
Standard Example 2, Examples 7 to 8, and Comparative Examples 2 to 3
The procedures of “Standard Example 1, Examples 1 to 6, and Comparative Example 1” were repeated except that the polyolefins listed in Table 4 were used as the polyolefin (B), and the physical properties were measured. The results showed various physical properties of Examples 7 to 8 and Comparative Examples 2 to 3 as indexes with the value of Standard Example 2 as 100.

The results are listed in Table 4.

TABLE 4

| | | Standard | Example | Example | Comparative | Comparative |
|---|---|---|---|---|---|---|
| | | Example 2 | 7 | 8 | Example 2 | Example 3 |
| NR *1 | | 50 | 50 | 50 | 50 | 50 |
| BR *2 | | 50 | 50 | 50 | 50 | 50 |
| Polyolefin | Polyolefin G | | 10 | | | |
| (B) | Polyolefin H | | | 10 | | |
| | Polyolefin I | | | | 10 | |
| | Polyolefin J | | | | | 10 |

| | | | | | |
|---|---|---|---|---|---|
| Silica *3 | 30 | 30 | 30 | 30 | 30 |
| Carbon black *4 | 10 | 10 | 10 | 10 | 10 |
| Silane coupling agent *5 | 2 | 2 | 2 | 2 | 2 |
| Zinc oxide *6 | 3 | 3 | 3 | 3 | 3 |
| Stearic acid *7 | 1.5 | 1.5 | 1.5 | 1.5 | 1.5 |
| Anti-aging agent *8 | 2 | 2 | 2 | 2 | 2 |
| Sulfur *9 | 2 | 2 | 2 | 2 | 2 |
| Vulcanization accelerator NS | 1.5 | 1.5 | 1.5 | 1.5 | 1.5 |
| *10 | | | | | |
| Vulcanization accelerator D | 0.5 | 0.5 | 0.5 | 0.5 | 0.5 |
| *11 | | | | | |
| Measurement result | | | | | |
| Strength at break at 20° C. | 100 | 102 | 101 | 91 | 102 |
| Elongation at break at 20° C. | 100 | 110 | 108 | 95 | 103 |
| Strength at break at 100° C. | 100 | 107 | 105 | 80 | 83 |
| Elongation at break at 100° C. | 100 | 117 | 110 | 99 | 93 |
| Heat build-up | 100 | 119 | 109 | 100 | 106 |

### Standard Example 3, Examples 9 to 11, and Comparative Example 4

The random polypropylene A, the random polypropylene D, the polyolefin G, or the random polypropylene K described below, the hydrolytically condensable silane compound described below, a free-radical generator, and an antioxidant were graft-reacted through the following extruder according to the formulation (parts by mass) in Table 5 described below to obtain a silyl group-containing polyolefin of Synthesis Examples 1 to 3.

As an extruder, an extruder having L/D=28 and a screw outer diameter of 65 mm was used. The temperature condition for each temperature zone was as follows. That is, the first region was 160° C., the second region was 180° C., the third region was 200° C., the fourth region was 230° C., the head region was 230° C., and the die region was 230° C. Under the conditions described above, the resultant product was extruded into strands, water-cooled, and pelletized by using a pelletizer.

TABLE 5

| | | | | For |
|---|---|---|---|---|
| | Synthesis | Synthesis | Synthesis | Comparative |
| | Example 1 | Example 2 | Example 3 | Examples |
| Random | A | D | G | K |
| polypropylene or | 100 | 100 | 100 | — |
| polyolefin | | | | |
| Hydrolytically | 1.9 | 1.9 | 1.9 | — |
| condensable silane | | | | |
| compound | | | | |
| Free-radical | 0.04 | 0.04 | 0.04 | — |
| generator | | | | |
| Antioxidant | 0.1 | 0.1 | 0.1 | — |
| Melting point (° C.) | 140 | 131 | 126 | 77 |
| MFR (g/10 min) | 43 | 28 | — | 17 |
| temperature 230° C., | | | | |
| load 2.16 kg | | | | |
| MFR (g/10 min) | — | — | 40 | — |
| temperature 190° C., | | | | |
| load 2.16 kg | | | | |

Hydrolytically condensable silane compound: Vinyltriethoxysilane (KBE 1003, manufactured Shin-Etsu Chemical Co., Ltd.)
Free-radical generator: Dicumyl peroxide
Antioxidant: Irganox 1010, available from BASF Japan Ltd.
Random polypropylene K (Linklon PM700N available from Mitsubishi Chemical Corporation)

The procedures of “Standard Example 1, Examples 1 to 6, and Comparative Example 1” were repeated except that the polyolefins listed in Table 6 were used as the polyolefin (B), and the physical properties were measured. The results showed various physical properties of Examples 9 to 11 and Comparative Example 4 as indexes with the value of Standard Example 3 as 100.

The results are listed in Table 6.

TABLE 6

| | | Standard | Example | Example | Example | Comparative |
|---|---|---|---|---|---|---|
| | | Example 3 | 9 | 10 | 11 | Example 4 |
| NR *1 | | 50 | 50 | 50 | 50 | 50 |
| BR *2 | | 50 | 50 | 50 | 50 | 50 |
| Polyolefin (B) | Synthesis Example 1 | | 10 | | | |
| | Synthesis Example 2 | | | 10 | | |
| | Synthesis Example 3 | | | | 10 | |
| | Random | | | | | 10 |
| | polypropylene K | | | | | |

| | | | | | |
|---|---|---|---|---|---|
| Silica *3 | 30 | 30 | 30 | 30 | 30 |
| Carbon black *4 | 10 | 10 | 10 | 10 | 10 |
| Silane coupling agent *5 | 2 | 2 | 2 | 2 | 2 |
| Zinc oxide *6 | 3 | 3 | 3 | 3 | 3 |
| Stearic acid *7 | 1.5 | 1.5 | 1.5 | 1.5 | 1.5 |
| Anti-aging agent *8 | 2 | 2 | 2 | 2 | 2 |
| Sulfur *9 | 2 | 2 | 2 | 2 | 2 |
| Vulcanization accelerator NS *10 | 1.5 | 1.5 | 1.5 | 1.5 | 1.5 |
| Vulcanization accelerator D *11 | 0.5 | 0.5 | 0.5 | 0.5 | 0.5 |
| Measurement result | | | | | |
| Strength at break at 20° C. | 100 | 107 | 106 | 117 | 89 |
| Elongation at break at 20° C. | 100 | 103 | 102 | 111 | 107 |
| Strength at break at 100° C. | 100 | 116 | 116 | 104 | 76 |
| Elongation at break at 100° C. | 100 | 109 | 108 | 118 | 99 |
| Heat build-up | 100 | 125 | 123 | 119 | 111 |

### Standard Example 4, Examples 12 to 13, and Comparative Example 5

The random polypropylene A, the random polypropylene D, or the random polypropylene F, a maleic anhydride, a free-radical generator, and an antioxidant were subjected to a graft reaction through the following extruder according to a formulation (parts by mass) in Table 7 described below to obtain a polyolefin (B) of Synthesis Examples 4 to 6.

As an extruder, an extruder having L/D=28 and a screw outer diameter of 65 mm was used. The temperature condition for each temperature zone was as follows. That is, the first region was 160° C., the second region was 180° C., the third region was 200° C., the fourth region was 230° C., the head region was 230° C., and the die region was 230° C. Under the conditions described above, the resultant product was extruded into strands, water-cooled, and pelletized by using a pelletizer.

TABLE 7

| | | | Synthesis |
|---|---|---|---|
| | | | Example 6 |
| | | | (For |
| | Synthesis | Synthesis | Comparative |
| | Example 4 | Example 5 | Example) |
| Random polypropylene | A | D | F |
| | 100 | 100 | 100 |
| Maleic anhydride | 0.6 | 0.6 | 0.6 |
| Free-radical generator | 0.04 | 0.04 | 0.04 |
| Antioxidant | 0.1 | 0.1 | 0.1 |
| Melting point (° C.) | 142 | 129 | 145 |
| MFR (g/10 min) temperature | 47 | 32 | 3 |
| 230° C., load 2.16 kg | | | |

Maleic anhydride (available from Tokyo Chemical Industry Co., Ltd.)
Free-radical generator: Dicumyl peroxide
Antioxidant: Irganox 1010, available from BASF Japan Ltd.

The procedures of “Standard Example 1, Examples 1 to 6, and Comparative Example 1” were repeated except that the polyolefins listed in Table 8 were used as the polyolefin (B), and the physical properties were measured. The results showed various physical properties of Examples 12 to 13 and Comparative Example 5 as indexes with the value of Standard Example 4 as 100.

The results are listed in Table 8.

TABLE 8

| | | Standard | Example | Example | Comparative |
|---|---|---|---|---|---|
| | | Example 4 | 12 | 13 | Example 5 |
| SBR *12 | | 100 | 100 | 100 | 100 |
| Polyolefin (B) | Synthesis Example 4 | | 10 | | |
| | Synthesis Example 5 | | | 10 | |
| | Synthesis Example 6 | | | | 10 |

| | | | | |
|---|---|---|---|---|
| Silica *3 | 30 | 30 | 30 | 30 |
| Carbon black *4 | 30 | 30 | 30 | 30 |
| Silane coupling agent *5 | 2 | 2 | 2 | 2 |
| Zinc oxide *6 | 3 | 3 | 3 | 3 |
| Stearic acid *7 | 1.5 | 1.5 | 1.5 | 1.5 |
| Anti-aging agent *8 | 2 | 2 | 2 | 2 |
| Sulfur *9 | 1.5 | 1.5 | 1.5 | 1.5 |
| Vulcanization accelerator NS *10 | 1.5 | 1.5 | 1.5 | 1.5 |
| Vulcanization accelerator D *11 | 0.5 | 0.5 | 0.5 | 0.5 |
| Measurement result | | | | |
| Strength at break at 20° C. | 100 | 108 | 110 | 104 |
| Elongation at break at 20° C. | 100 | 109 | 114 | 88 |
| Strength at break at 100° C. | 100 | 105 | 108 | 100 |
| Elongation at break at 100° C. | 100 | 110 | 114 | 98 |
| Heat build-up | 100 | 102 | 104 | 102 |

*12: SBR (Nipol 1502, available from Zeon Corporation)

From the results in the respective Tables, it can be seen that each Example of the rubber composition (1) of the present technology, containing a polyolefin having a melting point of 110° C. or higher and 155° C. or lower and a melt mass flow rate (MFR), measured at a temperature of 230° C. under a load of 2.16 kg, of more than 6 g/10 min or a melt mass flow rate (MFR), measured at a temperature of 190° C. under a load of 2.16 kg, of 10 g/10 min or more in an amount of from 1 to 200 parts by mass per 100 parts by mass of the rubber component (A) containing 50 parts by mass or more of a diene rubber, can provide a rubber composition having excellent strength at break under high temperature and low heat build-up.

In contrast, in Comparative Example 1, because the melt mass flow rate (MFR) of the random polypropylene measured at a temperature of 230° C. under a load of 2.16 kg was less than the lower limit specified in the present technology, the elongation at break at 20° C. and 100° C. deteriorated.

In Comparative Example 2, because the melt mass flow rate (MFR) of the polyolefin measured at a temperature of 190° C. under a load of 2.16 kg was less than 10 g/10 min, both the strength at break at 20° C. and 100° C. and the elongation at break at 20° C. and 100° C. deteriorated.

In Comparative Example 3, because the melting point of the polyolefin was less than 110° C., the strength at break and the elongation at break at 100° C. deteriorated.

In Comparative Example 4, because the melting point of the random polypropylene was less than 110° C., the strength at break at 20° C., and the strength at break and the elongation at break at 100° C. deteriorated.

In Comparative Example 5, because the melt mass flow rate (MFR) of the polyolefin measured at a temperature of 230° C. under a load of 2.16 kg was less than 5 g/10 min, both the strength at break at 20° C. and 100° C. and the elongation at break at 20° C. and 100° C. deteriorated.

Next, Examples and Comparative Examples of the rubber composition (2) of the present technology will be described.

### Standard Example 5, Examples 14 to 21, and Comparative Examples 6 to 9

According to the blending proportion (parts by mass) listed in Table 9, the components other than the vulcanization components (vulcanization accelerators and sulfur) were mixed for 5 minutes in a Banbury mixer at 80° C. The temperature reached at that time was 150° C. Then, the vulcanization components were added and mixed by using a roll and thus a rubber composition was obtained. A vulcanized rubber test piece was produced by press-vulcanizing each obtained rubber composition (unvulcanized) at 170° C. for 10 minutes in a mold (15 cm×15 cm×0.2 cm), and the following evaluations were performed.

### Heat Build-Up: tan δ (60° C.) Index

The loss tangent at a temperature of 60° C., tan δ (60° C.), was measured for each of the vulcanized rubber test pieces produced as described above using a viscoelastic spectrometer (available from Toyo Seiki Seisaku-sho, Ltd.) under the following conditions: 10% initial strain, ±2% amplitude, and 20 Hz frequency, and the heat build-up was evaluated.

The reciprocal of the obtained tan δ (60° C.) was calculated, and the result was listed in the column of “Heat build-up” as an index with the value of Standard Example 5 as 100. The larger these indexes are, the lower heat build-up is, which is preferable.

### Steering Stability: Hardness

For the vulcanized rubber test piece produced as described above, the hardness was measured at 20° C. in accordance with JIS K6253. The results were expressed as index values with Standard Example 5 being assigned the value of 100. A larger index value indicates higher hardness and superior steering stability.

The results are listed in Table 9.

TABLE 9-1

| | | Standard | Example | Example | Example |
|---|---|---|---|---|---|
| | | Example 5 | 14 | 15 | 16 |
| NR *1 | | 100 | 100 | 100 | 100 |
| BR *2 | | | | | |
| Silica *3 | | 10 | 10 | 10 | 10 |
| Carbon black A *13 | | 35 | 32 | 32 | 32 |
| Carbon black B *14 | | | | | |
| Carbon black C *15 | | | | | |
| High-fluidity | Random | | 5 | | |
| random | polypropylene A | | | | |
| polypropylene | Random | | | 5 | |
| | polypropylene B | | | | |
| | Random | | | | 5 |
| | polypropylene C | | | | |
| | Random | | | | |
| | polypropylene D | | | | |
| | Random | | | | |
| | polypropylene E | | | | |
| | Random | | | | |
| | polypropylene F | | | | |

| | | | | |
|---|---|---|---|---|
| Silane coupling agent *5 | 1 | 1 | 1 | 1 |
| Stearic acid *7 | 1.5 | 1.5 | 1.5 | 1.5 |
| Anti-aging agent *8 | 1.5 | 1.5 | 1.5 | 1.5 |
| Zinc oxide *6 | 3 | 3 | 3 | 3 |
| Vulcanization accelerator NS *16 | 1.5 | 1.5 | 1.5 | 1.5 |
| Sulfur *9 | 2 | 2 | 2 | 2 |
| Amount of filler | 45 | 45 | 42 | 42 |
| Measurement result | | | | |
| Heat build-up | 100 | 110 | 109 | 113 |
| Steering stability | 100 | 105 | 107 | 106 |

TABLE 9-2

| | | Example | Example | Example | Example | Example |
|---|---|---|---|---|---|---|
| | | 17 | 18 | 19 | 20 | 21 |
| NR *1 | | 100 | 100 | 100 | 85 | 100 |
| BR *2 | | | | | 15 | |
| Silica *3 | | 10 | 10 | | 10 | 10 |
| Carbon black A | | 32 | 32 | 42 | 32 | |
| *13 | | | | | | |
| Carbon black B | | | | | | 35 |
| *14 | | | | | | |
| Carbon black C | | | | | | |
| *15 | | | | | | |
| High-fluidity | Random | | | | | |
| random | polypropylene A | | | | | |
| polypropylene | Random | | | | | |
| | polypropylene B | | | | | |
| | Random | | | | | |
| | polypropylene C | | | | | |
| | Random | 5 | | 5 | 5 | 5 |
| | polypropylene D | | | | | |
| | Random | | 5 | | | |
| | polypropylene E | | | | | |
| | Random | | | | | |
| | polypropylene F | | | | | |

| | | | | | |
|---|---|---|---|---|---|
| Silane coupling agent *5 | 1 | 1 | 1 | 1 | 1 |
| Stearic acid *7 | 1.5 | 1.5 | 1.5 | 1.5 | 1.5 |
| Anti-aging agent *8 | 1.5 | 1.5 | 1.5 | 1.5 | 1.5 |
| Zinc oxide *6 | 3 | 3 | 3 | 3 | 3 |
| Vulcanization accelerator NS *16 | 1.5 | 1.5 | 1.5 | 1.5 | 1.5 |
| Sulfur *9 | 2 | 2 | 2 | 2 | 2 |
| Amount of filler | 42 | 42 | 42 | 42 | 45 |
| Measurement result | | | | | |
| Heat build-up | 110 | 111 | 108 | 105 | 115 |
| Steering stability | 106 | 105 | 107 | 105 | 104 |

TABLE 9-3

| | | Comparative | Comparative | Comparative | Comparative |
|---|---|---|---|---|---|
| | | Example 6 | Example 7 | Example 8 | Example 9 |
| NR *1 | | 100 | 75 | 100 | 100 |
| BR *2 | | | 25 | | |
| Silica *3 | | 10 | 10 | 10 | 10 |
| Carbon black A *13 | | 32 | 32 | | 50 |
| Carbon black B *14 | | | | | |
| Carbon black C *15 | | | | 32 | |
| High-fluidity | Random | | | | |
| random | polypropylene A | | | | |
| polypropylene | Random | | | | |
| | polypropylene B | | | | |
| | Random | | | | |
| | polypropylene C | | | | |
| | Random | | 5 | 5 | 5 |
| | polypropylene D | | | | |
| | Random | | | | |
| | polypropylene E | | | | |
| | Random | 5 | | | |
| | polypropylene F | | | | |

| | | | | |
|---|---|---|---|---|
| Silane coupling agent *5 | 1 | 1 | 1 | 1 |
| Stearic acid *7 | 1.5 | 1.5 | 1.5 | 1.5 |
| Anti-aging agent *8 | 1.5 | 1.5 | 1.5 | 1.5 |
| Zinc oxide *6 | 3 | 3 | 3 | 3 |
| Vulcanization accelerator NS *16 | 1.5 | 1.5 | 1.5 | 1.5 |
| Sulfur *9 | 2 | 2 | 2 | 2 |
| Amount of filler | 42 | 42 | 42 | 60 |
| Measurement result | | | | |
| Heat build-up | 106 | 100 | 93 | 96 |
| Steering stability | 99 | 104 | 106 | 108 |

*13: Carbon black A (trade name: Show Black N339, available from Cabot Japan K.K.; nitrogen adsorption specific surface area (N₂SA) = 88 m²/g)
*14: Carbon black B (trade name: Show Black N550, available from Cabot Japan K.K.; nitrogen adsorption specific surface area (N₂SA) = 40 m²/g)
*15: Carbon black C (trade name: Show Black S118, available from Cabot Japan K.K.; nitrogen adsorption specific surface area (N₂SA) = 148 m²/g)
*16: Vulcanization accelerator NS (NOCCELER CZ-G, available from Ouchi Shinko Chemical Industrial Co., Ltd.) Standard Example 6, Examples 22 to 25

Using the silyl group-containing polyolefins obtained in Synthesis Examples 1 and 2, rubber compositions were obtained in the same manner as in the above-described “Standard Example 5, Examples 14 to 21, and Comparative Examples 6 to 9” according to the formulation (parts by mass) in Table 10, and <Heat build-up: tan δ (60° C.) index> and <Steering stability: hardness> were measured. The results were expressed as index values with Standard Example 6 being assigned the value of 100.

The results are listed in Table 10.

TABLE 10

| | | Standard | Example | Example | Example | Example |
|---|---|---|---|---|---|---|
| | | Example 6 | 22 | 23 | 24 | 25 |
| NR *1 | | 100 | 100 | 100 | 85 | 100 |
| BR *2 | | | | | 15 | |
| Silica *3 | | 10 | 10 | 10 | 10 | 10 |
| Carbon black A *13 | | 35 | 32 | 32 | 32 | |
| Carbon black B *14 | | | | | | 35 |
| Carbon black C *15 | | | | | | |
| Silyl group- | Synthesis | | 5 | | | |
| containing | Example 1 | | | | | |
| polyolefin | Synthesis | | | 5 | 5 | 5 |
| | Example 2 | | | | | |

| | | | | | |
|---|---|---|---|---|---|
| Silane coupling agent *5 | 1 | 1 | 1 | 1 | 1 |
| Stearic acid *7 | 1.5 | 1.5 | 1.5 | 2 | 2 |
| Anti-aging agent *8 | 1.5 | 1.5 | 1.5 | 2 | 2 |
| Zinc oxide *6 | 3 | 3 | 3 | 3 | 3 |
| Vulcanization accelerator NS *16 | 1.5 | 1.5 | 1.5 | 1.2 | 1.2 |
| Sulfur *9 | 2 | 2 | 2 | 1.4 | 1.4 |
| Amount of filler | 45 | 42 | 42 | 42 | 45 |
| Measurement result | | | | | |
| Heat build-up | 100 | 112 | 114 | 107 | 114 |
| Steering stability | 100 | 106 | 107 | 106 | 104 |

As listed in Tables 9 and 10, the rubber composition (2) in each Example is characterized by containing: a rubber component (A2) composed of isoprene-based rubber and butadiene rubber, the rubber component having a proportion of the butadiene rubber of 15 parts by mass or less when a total amount of the rubber component is taken as 100 parts by mass; a filler (D) in an amount of 45 parts by mass or less, which is composed of carbon black and/or silica having a nitrogen adsorption specific surface area (N₂SA) of from 40 to 130 m²/g; and a high-fluidity random polypropylene (C) in an amount of from 0.1 to 20 parts by mass, which has a melting temperature of 110° C. or higher and 155° C. or lower and a melt mass flow rate (MFR), as measured at a temperature of 230° C. under a load of 2.16 kg, of more than 6 g/10 min, per 100 parts by mass of the rubber component, and the rubber composition (2) thus has low heat build-up and excellent steering stability.

In contrast, in Comparative Example 6, because the melt mass flow rate (MFR) of the random polypropylene measured at a temperature of 230° C. under a load of 2.16 kg was 6 g/10 min or less, there was no improvement in steering stability as compared with Standard Example 5.

In Comparative Example 7, because the blending amount of the butadiene rubber exceeded the upper limit specified in the present technology, there was no improvement in the heat build-up as compared with Standard Example 5.

In Comparative Example 8, because the nitrogen adsorption specific surface area (N₂SA) of the carbon black exceeded the upper limit specified in the present technology, the heat build-up deteriorated as compared with Standard Example 5.

In Comparative Example 9, because the blending amount of the filler exceeded the upper limit specified in the present technology, the heat build-up deteriorated as compared with Standard Example 5.

### Examples 26 to 27

The rubber composition was repeated in the same manner as in the above-described “Standard Example 5, Examples 14 to 21, and Comparative Examples 6 to 9” except that the high-fluidity random polypropylenes listed in Table 11 were used as the high-fluidity random polypropylene (C), and various physical properties were measured. The results were expressed as index values with Standard Example 5 being assigned the value of 100.

The results are listed in Table 11.

TABLE 11

| | | Standard | | |
|---|---|---|---|---|
| | | Example 5 | Example 26 | Example 27 |
| NR *1 | | 100 | 100 | 100 |
| BR *2 | | | | |
| Silica *3 | | 10 | 15 | 20 |
| Carbon black A *13 | | 35 | 30 | 25 |
| Carbon black B *14 | | | | |
| Carbon black C *15 | | | | |
| High-fluidity | Random polypropylene A | | | |
| random | Random polypropylene B | | | |
| polypropylene | Random polypropylene C | | | |
| | Random polypropylene D | | 10 | 18 |
| | Random polypropylene E | | | |
| | Random polypropylene F | | | |

| | | | |
|---|---|---|---|
| Silane coupling agent *5 | 1 | 1 | 1 |
| Stearic acid *7 | 1.5 | 1.5 | 1.5 |
| Anti-aging agent *8 | 1.5 | 1.5 | 1.5 |
| Zinc oxide *6 | 3 | 3 | 3 |
| Vulcanization accelerator NS *16 | 1.5 | 1.5 | 1.5 |
| Sulfur *9 | 2 | 2 | 2 |
| Amount of filler | 45 | 45 | 42 |
| Measurement result | | | |
| Heat build-up | 100 | 105 | 107 |
| Steering stability | 100 | 110 | 114 |

The present disclosure includes the following technologies.

Technology [1]: A rubber composition containing, per 100 parts by mass of a rubber component (A) containing 50 parts by mass or more of a diene rubber, a polyolefin (B) in an amount of from 1 to 200 parts by mass, the polyolefin (B) having a melting point of 110° C. or higher and 155° C. or lower and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more.

Technology [2]: The rubber composition according to Technology 1, wherein the diene rubber is at least one selected from the group consisting of natural rubber, synthetic isoprene rubber, butadiene rubber, styrene-butadiene copolymer rubber, and acrylonitrile-butadiene copolymer rubber.

Technology [3]: The rubber composition according to Technology 1 or 2, wherein, per 100 parts by mass of the rubber component (A), carbon black and/or silica in an amount of from 20 to 200 parts by mass is further blended.

Technology [4] The rubber composition according to any of Technologies 1 to 3, wherein the polyolefin (B) is at least one selected from the group consisting of a propylene-ethylene random copolymer, a propylene-1-butene random copolymer, a propylene-ethylene-1-butene random copolymer, low-density polyethylene (LDPE), linear low-density polyethylene (LLDPE), and high-density polyethylene (HDPE).

Technology [5]: The rubber composition according to any of Technologies 1 to 4, wherein the polyolefin (B) has a melting point or 130° C. or higher and 150° C. or lower.

Technology [6] The rubber composition according to any of Technologies 1 to 5, wherein the polyolefin (B) has the melt mass flow rate (MFR), measured at a temperature of 230° C. under a load of 2.16 kg, of 8 g/10 min or more, or the melt mass flow rate (MFR), measured at a temperature of 190° C. under a load of 2.16 kg, of 20 g/10 min or more.

Technology [7] The rubber composition according to any of Technologies 1 to 6, wherein the polyolefin (B) is selected from a propylene-ethylene random copolymer, a propylene-1-butene random copolymer, and a propylene-ethylene-1-butene random copolymer.

Technology [8]: A method for producing a rubber composition, the method including: blending, per 100 parts by mass of a rubber component (A) containing 50 parts by mass or more of a diene rubber, a polyolefin (B) in an amount of from 1 to 200 parts by mass, the polyolefin (B) having a melting point of 110° C. or higher and 155° C. or lower and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more; and kneading an obtained blend under a condition of a temperature equal to or higher than a melting point of the polyolefin (B).

Technology [9] A rubber composition for a heavy duty tire undertread, the rubber composition containing: a rubber component (A2) composed of an isoprene-based rubber and a butadiene rubber, the rubber component (A2) having a proportion of the butadiene rubber of 15 parts by mass or less when a total amount of the rubber component (A2) is taken as 100 parts by mass; and per 100 parts by mass of the rubber component, a filler (D) in an amount of 45 parts by mass, the filler (D) composed of carbon black and/or silica having a nitrogen adsorption specific surface area (N₂SA) of from 40 to 130 m²/g; and a high-fluidity random polypropylene (C) in an amount of from 0.1 to 20 parts by mass, the high-fluidity random polypropylene (C) having a melting point of 110° C. or higher and 155° C. or lower and a melt mass flow rate (MFR), measured at a temperature of 230° C. under a load of 2.16 kg, of more than 6 g/10 min.

Technology [10]: The rubber composition for a heavy duty tire undertread according to Technology 9, wherein the high-fluidity random polypropylene (C) has a hydrolytically condensable silyl group in a molecule, and the silica is contained in an amount of 5 parts by mass or more per 100 parts by mass of the rubber component (A2).

Technology [11]: The rubber composition for a heavy duty tire undertread according to Technology 9 or 10, wherein the high-fluidity random polypropylene (C) is selected from a propylene-ethylene random copolymer, a propylene-1-butene random copolymer, and a propylene-ethylene-1-butene random copolymer.

Technology [12]: The rubber composition according to any of Technologies 9 to 11, wherein the high-fluidity random polypropylene (C) has a melting point of 130° C. or higher and 150° C. or lower.

Technology [13]: The rubber composition according to any of Technologies 9 to 12, wherein the high-fluidity random polypropylene (C) has the melt mass flow rate (MFR), measured at a temperature of 230° C. under a load of 2.16 kg, of 8 g/10 min or more.

Technology [14]: A tire using the rubber composition according to any of Technologies 1 to 7.

Technology [15]: A heavy duty tire using the rubber composition according to any of Technologies 9 to 13.

1-15. (canceled)

16. A rubber composition comprising, per 100 parts by mass of a rubber component (A) containing 50 parts by mass or more of a diene rubber,
a polyolefin (B) in an amount of from 1 to 200 parts by mass, the polyolefin (B) having a melting point of 110° C. or higher and 155° C. or lower and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more.

17. The rubber composition according to claim 16, wherein the diene rubber is at least one selected from the group consisting of natural rubber, synthetic isoprene rubber, butadiene rubber, styrene-butadiene copolymer rubber, and acrylonitrile-butadiene copolymer rubber.

18. The rubber composition according to claim 16, wherein, per 100 parts by mass of the rubber component (A), carbon black and/or silica in an amount of from 20 to 200 parts by mass is further blended.

19. The rubber composition according to claim 16, wherein the polyolefin (B) is at least one selected from the group consisting of a propylene-ethylene random copolymer, a propylene-1-butene random copolymer, a propylene-ethylene-1-butene random copolymer, low-density polyethylene (LDPE), linear low-density polyethylene (LLDPE), and high-density polyethylene (HDPE).

20. The rubber composition according to claim 16, wherein the polyolefin (B) has a melting point or 130° C. or higher and 150° C. or lower.

21. The rubber composition according to claim 16, wherein the polyolefin (B) has the melt mass flow rate (MFR), measured at a temperature of 230° C. under a load of 2.16 kg, of 8 g/10 min or more, or the melt mass flow rate (MFR), measured at a temperature of 190° C. under a load of 2.16 kg, of 20 g/10 min or more.

22. The rubber composition according to claim 16, wherein the polyolefin (B) is selected from a propylene-ethylene random copolymer, a propylene-1-butene random copolymer, and a propylene-ethylene-1-butene random copolymer.

23. A method for producing a rubber composition, the method comprising:
blending, per 100 parts by mass of a rubber component (A) containing 50 parts by mass or more of a diene rubber, a polyolefin (B) in an amount of from 1 to 200 parts by mass, the polyolefin (B) having a melting point of 110° C. or higher and 155° C. or lower and a melt mass flow rate (MFR), measured at a temperature of 230° C. under a load of 2.16 kg, of more than 6 g/10 min, or a melt mass flow rate (MFR), measured at a temperature of 190° C. under a load of 2.16 kg, of 10 g/10 min or more; and
kneading an obtained blend under a condition of a temperature equal to or higher than a melting point of the polyolefin (B).

24. A rubber composition for a heavy duty tire undertread, the rubber composition comprising:
a rubber component (A2) composed of an isoprene-based rubber and a butadiene rubber, the rubber component (A2) having a proportion of the butadiene rubber of 15 parts by mass or less when a total amount of the rubber component (A2) is taken as 100 parts by mass; and per 100 parts by mass of the rubber component,
a filler (D) in an amount of 45 parts by mass, the filler (D) composed of carbon black and/or silica having a nitrogen adsorption specific surface area (N₂SA) of from 40 to 130 m²/g; and
a high-fluidity random polypropylene (C) in an amount of from 0.1 to 20 parts by mass, the high-fluidity random polypropylene (C) having a melting point of 110° C. or higher and 155° C. or lower and a melt mass flow rate (MFR), measured at a temperature of 230° C. under a load of 2.16 kg, of more than 6 g/10 min.

25. The rubber composition for a heavy duty tire undertread according to claim 24, wherein the high-fluidity random polypropylene (C) has a hydrolytically condensable silyl group in a molecule, and
the silica is contained in an amount of 5 parts by mass or more per 100 parts by mass of the rubber component (A2).

26. The rubber composition for a heavy duty tire undertread according to claim 24, wherein the high-fluidity random polypropylene (C) is selected from a propylene-ethylene random copolymer, a propylene-1-butene random copolymer, and a propylene-ethylene-1-butene random copolymer.

27. The rubber composition for a heavy duty tire undertread according to claim 24, wherein the high-fluidity random polypropylene (C) has a melting point of 130° C. or higher and 150° C. or lower.

28. The rubber composition for a heavy duty tire undertread according to claim 24, wherein the high-fluidity random polypropylene (C) has the melt mass flow rate (MFR), measured at a temperature of 230° C. under a load of 2.16 kg, of 8 g/10 min or more.

29. A tire using the rubber composition according to claim 16.

30. A heavy duty tire using the rubber composition for a heavy duty tire undertread according to claim 24.
